(19) United States
(12) Patent Application Publication
(10) Pub. No.: US 2008/0264255 A1
(43) Pub. Date: Oct. 30, 2008

(54) PROCESSES FOR REMOVING SOx AND SULFURIC ACID AEROSOLS FROM CHLORINE-CONTAINING PROCESS GASES

(75) Inventors: Torsten Erwe, Odenthal (DE); Martin Weiss, Bornheim/Sechtem (DE); Knud Werner, Krefeld (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/110,546

(22) Filed: Apr. 28, 2008

(30) Foreign Application Priority Data
Apr. 26, 2007 (DE) 102007020141.0

(51) Int. Cl. B01D 53/14

(52) U.S. Cl. 95/210

(57) ABSTRACT

Processes comprising: providing a gas comprising chlorine and at least one sulfur-containing component; and countercurrently contacting the gas with circulating chlorine-containing water in a column such that the at least one sulfur-containing component is oxidized with chlorine in the chlorine-containing water to form sulfate and chloride and a portion of the chlorine from the gas is absorbed by the water to an equilibrium.

### BACKGROUND OF THE INVENTION

Chlorine-containing process gases are often dried by means of sulfuric acid. However, in so doing, SOₓ and sulfuric acid aerosols are released into the chlorine gas.

Sulfur-containing compounds are catalyst poisons and therefore have to be removed from the process gas down to the lowest possible concentration upstream of catalysts. Removing SOₓ and sulfuric acid aerosols from process gases while simultaneously minimizing fresh water consumption is problematic in conventional systems.

Conventional prior art absorber processes exhibit elevated fresh water requirements and provide relatively ineffective depletion rates. Waste gases containing SOₓ are conventionally treated either by means of a) absorbers in recirculation mode with addition of sodium hydroxide solution, or b) in once-through mode with water.

In the case of chlorine-containing gases, sodium hydroxide solution cannot be used as this would also remove a large proportion of the chlorine from the gas.

Conventionally, the achievable purity of the gas stream is substantially determined by the quantity of fresh water. When packed columns are used, the minimum fresh water requirement is predetermined by the spray density which is necessary. Large quantities of fresh water are consequently required.

### BRIEF SUMMARY OF THE INVENTION

In the processes according to the present invention, in contrast, an improved process concept ensures elevated purity of the chlorine gas combined with minimal fresh water consumption.

The processes of the present invention provide an improved absorber concept. In this concept, the scrubbing water is not passed through the column in a single pass, as is conventional, but is instead circulated. Only a small proportion of the water is continuously removed. This mode of operation is possible because chlorine is likewise absorbed from the chlorine-containing process gas and said chlorine immediately reacts in the aqueous phase with the dissolved SOₓ to yield sulfate and chloride. As a consequence, the sulfur compounds have no vapor pressure over the recirculating water.

The present invention provides an advantageous solution to the problem of removing SOₓ and sulfuric acid aerosols from process gases while simultaneously minimizing fresh water consumption.

One embodiment according to the present invention includes processes comprising:
providing a gas comprising chlorine and at least one sulfur-containing component; and
countercurrently contacting the gas with circulating chlorine-containing water in a column such that the at least one sulfur-containing component is oxidized with chlorine in the chlorine-containing water to form sulfate and chloride and a portion of the chlorine from the gas is absorbed by the water to an equilibrium.

### DETAILED DESCRIPTION OF THE INVENTION

As used herein, the singular terms “a” and “the” are synonymous and used interchangeably with “one or more” and “at least one,” unless the language and/or context clearly indicates otherwise. Accordingly, for example, reference to “a gas” herein or in the appended claims can refer to a single gas or more than one gas. Additionally, all numerical values, unless otherwise specifically noted, are understood to be modified by the word “about.”

In the processes according to the present invention, the chlorine gas can be introduced into the bottom of a scrubbing column, where it is scrubbed countercurrently with warm, chlorine-containing water. To this end, this water can be sprayed onto packing pieces or a structured packing. In this manner, SO₂ gas is oxidized to yield SO₄²⁻ and can be removed from the gas phase. Oxidation can be effected by the likewise dissolved chlorine. SO₃ dissolves in the scrubbing water and likewise forms SO₄²⁻. By absorption of the chlorine from the gas phase, the chlorine-containing water is formed until an equilibrium is established, after which chlorine is only subsequently absorbed in the same quantity as is consumed on oxidation of the sulfur compounds.

Water condenses onto H₂SO₄ mist causing the mist droplets to grow. Growth is promoted by a scrubbing liquid temperature which is greater than the gas inlet temperature. The temperature difference is preferably at least 10° C. The mist droplets are removed from the gas stream in a filter (denuder system) downstream from the scrubbing column. The filter medium typically consists of glass fiber mats and through-flow is arranged such that, due to Brownian motion, even very small drops come into contact with the fibers where they separate out.

The process can advantageously be used for the desulfarization of chlorine-containing product gas from the, in particular, thermocatalytic oxidation of hydrogen chloride with oxygen, e.g., by the known Deacon process.

The invention will now be described in further detail with reference to the following non-limiting examples.

### EXAMPLES

In two experiments a gas mixture containing chlorine and a gas mixture free of chlorine were introduced into the bottom of a scrubbing column, in which they were washed countercurrently with warm water. For this purpose the water was sprayed onto packings. Mist droplets containing sulphuric acid were removed from the gas stream in a denuder system (glass mat) arranged downstream of the scrubbing column. The scrubbing water used was recycled into the column in a circulation loop.

The experiments were conducted using various gas mixtures containing SO₂ as the sulphur-containing example component.

The operating conditions were as follows:

| Column diameter: | 55 | mm |
|---|---|---|
| Bed height: | 70 | cm |
| Packings: | 6 | mm glass rings |
| Recirculated quantity: | 8 | 1/h |
| Temperature: | 22° | C. |
| Gas flow rate: | 500 | 1/h |
| Duration of the experiment: | 1 | h |
| Removal: | No removal | |
| SO₂ concentration: | 2 | g/Nm³ |

Gas mixture I contained only nitrogen in addition to SO₂ (comparison).

Gas mixture II additionally contained 5% by volume of chlorine (according to the invention).

After conducting the experiment for one hour, 1300 mg/Nm³ SO₂ were still contained in the pure gas of gas mixture I. Only 65 mg/Nm³ SO₂ were still contained in the pure gas of gas mixture II.

In the experiment using gas mixture II the SO₂ was oxidized to form sulphate by the chlorine also absorbed and removed from the gas phase.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A process comprising:
providing a gas comprising chlorine and at least one sulfur-containing component; and
countercurrently contacting the gas with circulating chlorine-containing water in a column such that the at least one sulfur-containing component is oxidized with chlorine in the chlorine-containing water to form sulfate and chloride and a portion of the chlorine from the gas is absorbed by the water to an equilibrium.

2. The process according to claim 1, wherein the circulating chlorine-containing water is passed through the column at a temperature higher than the gas temperature.

3. The process according to claim 1, wherein the circulating chlorine-containing water is passed through the column at a temperature at least 10° C. higher than the gas temperature.

4. The process according to claim 1, wherein the at least one sulfur-containing component comprises a sulfuric acid aerosol, and wherein the process further comprises downstream separating of sulfuric acid droplets formed by condensation of water onto the sulfuric acid aerosol from the water.

5. The process according to claim 4, wherein the downstream separation is carried out in a denuder system.

6. The process according to claim 2, wherein the at least one sulfur-containing component comprises a sulfuric acid aerosol, and wherein the process further comprises downstream separating of sulfuric acid droplets formed by condensation of water onto the sulfuric acid aerosol from the water.

7. The process according to claim 6, wherein the downstream separation is carried out in a denuder system.

8. The process according to claim 3, wherein the at least one sulfur-containing component comprises a sulfuric acid aerosol, and wherein the process further comprises downstream separating of sulfuric acid droplets formed by condensation of water onto the sulfuric acid aerosol from the water.

9. The process according to claim 8, wherein the downstream separation is carried out in a denuder system.
